(19) United States
(12) Patent Application Publication
(10) Pub. No.: US 2006/0084037 A1
(43) Pub. Date: Apr. 20, 2006

(54) Method and device for simplifying the bonding of porcelain veneers

(76) Inventor: Philip Gold, Plainview, NY (US)

Correspondence Address: Thomas Spinelli;Scully, Scott, Murphy & Presser, Ste. 300, 400 Garden City Plaza, Garden City, NY, 11530, US

(21) Appl. No.: 10/967,531

(22) Filed: Oct. 18, 2004

(51) Int. Cl. A61C 5/00; A61C 19/10

(52) U.S. Cl. 433/215; 206/83

(57) ABSTRACT

An apparatus and method for holding dental laminates is provided. A sheet is provided with an attachment means running along the center of the sheet that attaches the dental laminates to the sheet. The sheet may be stacked on top of several other similar sheets to form a pad. The pad is placed onto a platform such as a base, and inserted into an opaque box that blocks out the light so the light sensitive resin placed on the dental laminates does not cure until the dentist is ready to place the dental laminates onto a patient's teeth. The dental laminates can be held in the box until the dentist is ready to place the dental laminates onto a patient's teeth.

### BACKGROUND OF THE INVENTION

1. Field of the Invention

The present invention relates to dental laminates, and more specifically, to an apparatus and method for securely holding the dental laminates before, during and after they are loaded with bonding cement, allowing for easy stress free placement on the treated teeth.

2. Prior Art

A dental laminate is a thin plastic or porcelain veneer produced in a dental laboratory and then bonded to a tooth or teeth to improve its appearance. Dental laminates (veneers) are all white, thin ceramic shells, which fit precisely onto the faces of prepared anterior teeth. Like bonding, veneers are used to cover up discoloration, gaps, cracks and chipping, and to change the shape or size of the teeth. Veneers outperform bonding with greater resilience and a greater resistance to stains and dulling.

Most veneer procedures require two appointments to complete, the first of which is dedicated to preparing and taking an impression of the teeth. Veneers are minimally invasive restorations. Therefore, only a small portion of the face and top edge of a tooth are removed to achieve a proper preparation design. After the tooth or teeth are prepared, an impression is taken, which, along with accompanying photos and models, are sent to a dental laboratory. The laboratory fabricates porcelain shells, which fit onto the teeth, and are the dental laminates.

During a second appointment, the dental laminates are cemented onto the teeth. A dentist will first give a “trial fitting” of the veneers by using water or glycerin to attach them to the teeth. The dentist then cleans the teeth with bond-aiding chemicals and cements the veneers to the teeth. Placing dental laminates is a meticulous and delicate procedure. Each veneer must be trial fitted and assessed for aesthetic and functional success before final cementation. If required, fine adjustments are made prior to or immediately after final cementation. The dental laminates can be placed with a light sensitive resin, which is hardened by using an ultraviolet light.

However, there is no apparatus known in the art for assisting a dentist in holding these dental laminates in a secure manner once they are received from the dental laboratory and after a “trial fitting”, until they are ready for placement onto a patent's tooth or teeth. Once the laminates are received from the dental laboratory and a trial fitting is performed, the laminates are loaded with a resin. It is difficult to place these laminates in an area that holds them safely and securely, because the resin on the laminates is light sensitive. Therefore, it is important that the resin on the laminates does not harden while the dentist cleans the patient's teeth and prepares the patient's mouth, until the dental laminates are ready for insertion or placement onto a patient's tooth or teeth.

### SUMMARY OF THE INVENTION

Therefore, it is an object of the present invention to provide an apparatus and method to securely hold dental laminates once received from the dental laboratory, in a manner so that the resin does not harden, until the dentist is ready for final placement of the dental laminates onto a patient's teeth. It is a further object of the present invention to hold the veneers before, during and after the trial fitting, and allow for secure loading of cement onto the veneers with no hands required to hold the veneers to stop them from moving around. Finally, it is a further object of the present invention to allow for an easy line up and orientation of the veneers both before and after loading of the cement.

Accordingly, a kit for holding one or more dental laminates is provided, which comprises a housing for blocking out light, a holding means, and an attachment means for attaching one or more dental laminates to the holding means, wherein the holding means is placed inside the housing.

The kit for holding one or more dental laminates further comprises a base that attaches to the holding means, where the base is placed inside the housing. The holding means can be a sheet, such as a resin sheet. The holding means may also be a base. The attachment means can be an adhesive, such as cement, paste, glue and epoxy resin. The attachment means can also be a strip located at a mid-point of the holding means, or can be a double-sided adhesive strip. The attachment means can also be any slip-free material.

The holding means can also comprise a plurality of sheets forming a pad, where each of the sheets has the attachment means and the sheets are attached to each other. The kit further comprises a base attached to the pad, where the base is placed inside the housing.

The housing comprises an opaque box having a lid movable within an open and closed position. The box is made of a material selected from the group consisting of wood, plastic, stainless steel and metal. The one or more dental laminates have a light sensitive resin on a first side of the one or more dental laminates for bonding the one or more dental laminates to a patient's teeth.

Also provided is an apparatus for holding one or more dental laminates, the apparatus comprising a sheet and an attachment means placed on the sheet for attaching one or more dental laminates to the sheet. The apparatus further comprises a pad comprised of a plurality of sheets attached to each other, wherein the sheet is one of the plurality of sheets and each of the sheets has placed thereon the attachment means. The apparatus further comprises a base attached to the pad and a housing for holding the pad, the housing being opaque to block out light.

Also provided is an apparatus for holding one or more dental laminates, the apparatus comprising a base and an attachment means placed on the base for attaching one or more dental laminates to the base. The attachment means further comprises a housing for holding the base, the housing being opaque to block out light.

Also provided is a method of inserting one or more dental laminates onto a patient's teeth, the method comprising fitting one or more dental laminates onto a patient's teeth, loading a light sensitive resin onto the one or more dental laminates, and placing the one or more dental laminates onto a sheet having an attachment means for holding and securing the one or more dental laminates onto the sheet.

The method of inserting one or more dental laminates onto a patient's teeth further comprises removing the one or more dental laminates from the sheet for placement into a mouth of a patient. The method further comprises covering the one or more dental laminates to block out light, by holding the one or more dental laminates on the sheet in an opaque box. The method further comprises detaching the sheet from a pad comprising a plurality of sheets, thereby exposing a new sheet in the pad. The method further comprises loading a light sensitive resin onto a first side of the one or more dental laminates, and placing a second side of the one or more dental laminates on the sheet.

The above and other features of the invention, including various novel details of construction and combinations of parts, will now be more particularly described with reference to the accompanying drawings and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1a is a top view of an apparatus for holding dental laminates of the present invention.

FIG. 1b is a top view of an alternative embodiment of an apparatus for holding dental laminates of the present invention.

FIG. 2 is a side view of an apparatus for holding dental laminates of the present invention;

FIG. 3 is a top angled view of a kit for holding dental laminates of the present invention.

FIG. 4 is a top view of another alternative embodiment of an apparatus for holding dental laminates of the present invention.

### DETAILED DESCRIPTION OF THE PREFERRED EMBODIMENT

Although this invention is applicable to numerous and various medical or dental items that may need to be held or stored until a patient is ready for surgery or other medical procedures, it has been found particularly useful in the environment of holding dental laminates or veneers until a patient is ready for the placement of the dental laminates in their mouth. Therefore, without limiting the applicability of the invention to holding dental laminates, the invention will be described in such environment.

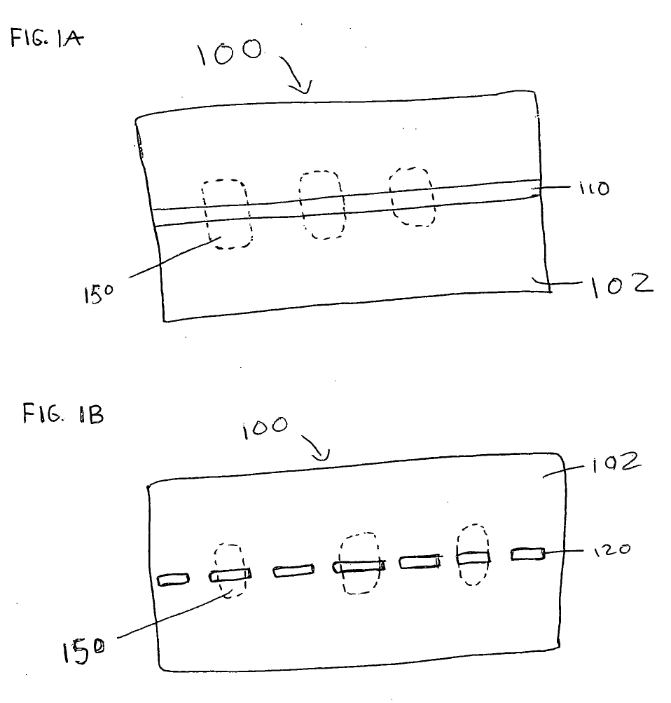

With reference now to the drawings, the components of the present invention will be described. FIG. 1a shows a top view of a sheet 100 in accordance with an embodiment of the present invention. The sheet 100 may be formed of various materials that may be sterilized and reusable such as stainless steel, or disposable such as resin. The sheet 100 may be of an adhesive or non-adhesive material. The sheet 100 may also be formed of but not limited to a paper, plastic, wood, vinyl, cardboard, or a metal. The sheet 100 can be of a variety of sizes (length and width) to accommodate more or less laminates as may be required, and may be of any thickness. For example, the sheet may be a thin sheet, such as a paper sheet, or may be of a thicker material, up to but not limited to 4 inches. The sheet 100 may be any sort of holding means that is able to hold the dental laminates as discussed below.

The sheet 100 has an attachment means 110 on a planar surface 102, which can be of various sizes. The attachments means 110 can be the size of the entire sheet 100, or of any smaller size placed on the sheet 100. The attachment means 110 is preferably placed at a mid point of the sheet 100. The attachment means 110 can also be placed at the top or the bottom of the sheet 100. The attachment means 110 can run across the entire sheet 100, from left to right or top to bottom, or be broken up. The attachment means 110 allows dental laminates 150 (shown in phantom) to be placed and held securely on the sheet 100 so that the dental laminates 150 do not move around, by attaching the dental laminates 150 to the sheet 100.

The attachment means 110 may be any sort of slip free material that holds or secures the dental laminates 150 thus preventing the dental laminates 150 from sliding or moving around on the sheet 100, and is not limited to the attachment means described below. The attachment means 110 may be a tacky sticky material, or any type of non-slip material that does not allow the laminates to slip or move around, and may come in strips as shown in FIGS. 1a and 1b. The attachment means 110 may be an adhesive material, and may be a strip, or may be a double-sided strip. The adhesive could be glue, paste, cement, epoxy resin or some other bonding agent known in the art. The strip may be removable, and may also be reusable if made of a material that is sterilizable. The attachment means 110 may also be a non-adhesive material, such as but not limited to a wax.

The attachment means 110 is preferably made of a biologically compatible material, which does not leave a residue on the dental laminates 150 once the dental laminates 150 are removed from the attachment means 110. Although the attachment means 110 is shown as a continuous strip across the sheet 100 as shown in FIG. 1a, the attachment means 110 may also be broken up into a segmented strip 120 as well, with each segment holding a different laminate 150, as shown in FIG. 1b. The continuous strip 110 or segmented strip 120 is used to attach the dental laminates 150 to the sheet 100, and hold the dental laminates 150 securely until they are ready to be placed on a patient's teeth.

For example, the dental laminates 150 may be placed on the sheet 100 in an order corresponding with the patient's teeth or in an order in which they will be placed in the patient's mouth. At that time, the dentist can smoothly remove the dental laminates 150 from the attachment means 110 or 120 on the sheet 100, and apply the dental laminates 150 to the patient's tooth or teeth in rapid succession.

FIG. 2 shows a side view of an embodiment of the present invention. A pad 210 that is comprised of a plurality of sheets 220 is provided that is supported by a base 200. The base 200 can be reusable and made of a material suitable for sterilizing, such as but not limited to stainless steel, or can be made of but not limited to plastic, wood, cardboard, vinyl, or any other type of metal. Each sheet 220 is easily removed from the pad 210. The pad 210 can be attached to the base 200 securely so as not to detach easily when each sheet 220 is removed from the pad 210. Each sheet 220 can be attached to the sheet below by an adhesive, or by means of the attachment means 110 itself used to secure the dental laminates. Each sheet 220 or the attachment means 110 can have a release material on it that allows an uppermost sheet 220 to be released easily from a sheet 220 below it in the pad 210. The attachment means 110 can be raised above the surface of the sheet 220.

Each sheet 220 can be discarded once the dental laminates 150 are used, and the new sheet 220 below in the pad 210 can be used for a new set of dental laminates 150. The sheets 220 can be made of a material that is reusable, such as stainless steel, or disposable, such as a resin or a paper or plastic product. When an uppermost sheet 220 is used, it can be removed to expose the next sheet 220 in the pad 210. After all the sheets 220 in the pad 210 are used, the base 200 can be discarded or used with another pad 210 of sheets 220. The pad 210 can be used by itself or with the base 200.

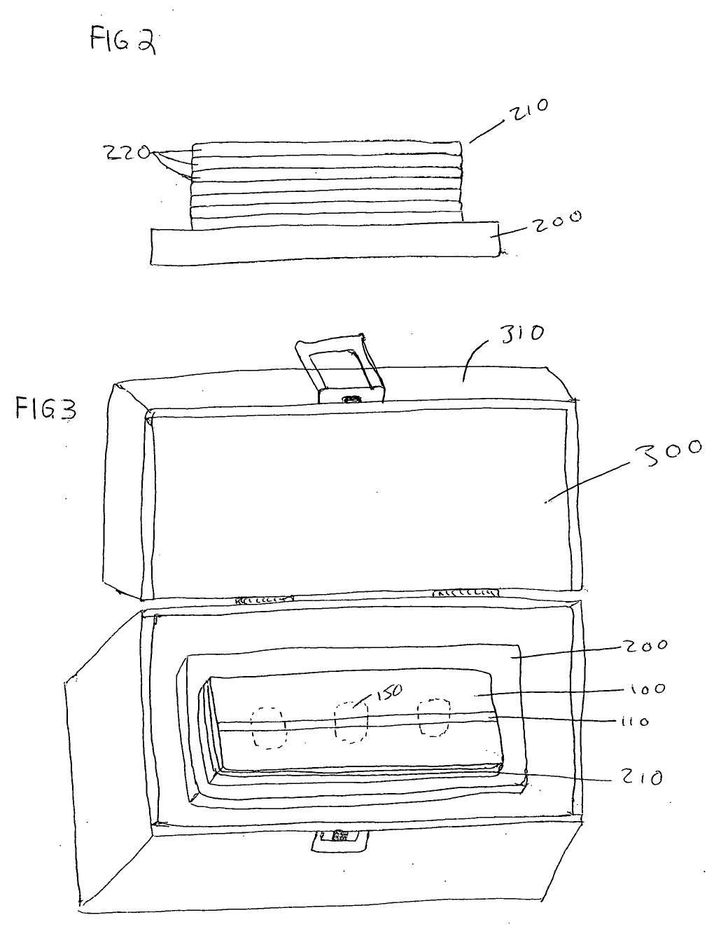

FIG. 3 shows a kit in accordance with the principles of the present invention comprising a box 300 that is used to enclose the pad 210. Light can cure the light sensitive resin placed on the dental laminates 150 that is used to bond the dental laminates 150 to the patient's teeth. Therefore, the box 300 is used to block out any light from the dental laminates 150 so that light does not cure the light sensitive resin on the dental laminates 150 until the dentist is ready to place the dental laminates 150 into the patient's mouth. The box 300 can be made of but is not limited to wood, vinyl, cardboard, plastic, metal or stainless steel, and can be reusable or disposable. The box 300 is preferably an opaque box to block out any light, and the box 300 can be any type of housing.

The box 300 is configured and sized so as to accept the base 200, which is attached to the pad 210 comprised of a plurality of sheets 220 as shown in FIG. 2 and described above. The box 300 is also configured to receive just the pad 210. Each sheet 100 has the attachment means 110 running across the center or mid-point of the sheet 100. Sheets 100 from FIGS. 1a and 1b can also be used with the box 300, either individually or in a form of a pad 210, as shown in FIG. 2. Dental laminates 150 are loaded onto the sheet 100 and attached to the attachment means 110, and can be held in the box 300 until the dentist is ready to place the dental laminates 150 onto a patient's teeth. The box 300 has a lid 310 that is movable between an open and closed position. The lid 310 may be a part of the box 300, may be a sliding lid, or may be a hinged lid connected to the box 300. The base 200 with the pad 210 can be inserted inside the box 300, or just the pad 210 can be inserted inside the box 300, or just the base 200 can be inserted inside the box 300, as described below.

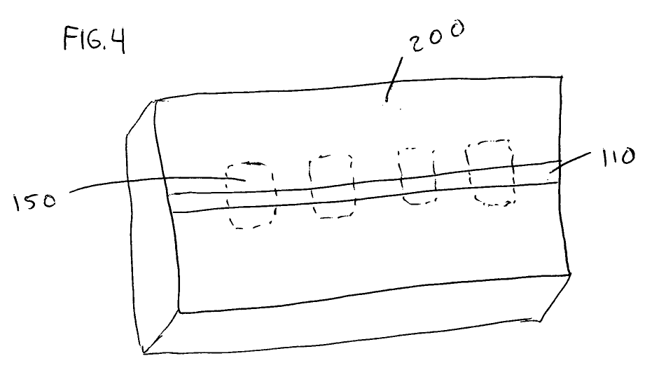

In an alternative embodiment, as shown in FIG. 4, the attachment means 110 can be placed on the base 200 itself, and the laminates 150 placed on the attachment means 110. Thus, the base 200 itself may be used by the dentist without the use of the sheet 100. The base 200 can then be placed inside the box 300 by itself to hold the dental laminates 150, or can be used with the pad 210, as described above.

Operation of the present invention will now be described with references to the figures and components described above.

Once the dental laminates 150 are prepared in the dental laboratory, the dental laminates are brought to the dentist for a trial fitting. The dental laminates may be brought on the sheet 100, and/or on the pad 210, and/or on the base 200, and/or inside the box 300. The dentist takes the dental laminates 150 and checks for a proper fitting of the dental laminates 150 on the patient's teeth. After checking the dental laminates 150 for a proper fit, they are loaded with a light sensitive resin cement. The dentist places the resin on a first side (inner side) of the dental laminate(s) that attaches to the tooth or teeth of the patient.

Because the light sensitive resin is also very sticky and the veneers are so small and delicate, they can slip and slide, easily causing the dentist to lose proper orientation of the veneers and cause a possible mix up of the dental laminates 150. By placing the dental laminates 150 face down on the non-slip surface and lined up in the proper order for insertion, the bonding cement can easily be syringed inside each veneer in rapid succession in a matter of seconds.

As the light sensitive resin cement on the dental laminates 150 will cure if exposed to light, and may move around and be misplaced, the dentist places the dental laminates 150 on the sheet 100. The dental laminates 150 attach to the sheet 100 by way of the attachment means 110. The dentist places the dental laminate(s) onto the sheet 100 so that a second side (outer side) of the dental laminate(s) touches the attachment means 110, thus securing the dental laminates 150 on the sheet 100. This is done so that the resin on the inner side of the dental laminate(s) does not touch the attachment means 110, and is exposed to the air. The dental laminates may be placed on an individual sheet 100, as shown in FIGS. 1a and 1b, or placed on a top most sheet 220 of the pad 210, as shown in FIG. 2. The pad 210 is preferably attached to the base 200.

The dental laminates 150 and sheet 220 are then preferably placed inside the housing or opaque box 300, which blocks out light. The sheet 100 can be placed inside the box 300 individually, or on the pad 210 holding the sheet 220. The sheet can be placed individually on the base 200, or the pad 210 can be placed on the base 200. Alternatively, the dental laminates 150 can be placed on the base 200 itself. Either the sheet 100 with the laminates 150 can be placed inside the box 300, or the pad 210 with the laminates 150 can be placed inside the box 300. The sheet 100 or the pad 210 can be placed on the base 200 and then placed inside the box 300. Alternatively, the base 200 can hold the laminates 150 and be placed inside the box 300.

In FIG. 3, the base 200 containing the pad 210 and the plurality of sheets 220 is placed into the box 300. Once the dental laminates 150 are placed inside the box 300 and secured to the sheet 220 by the attachment means 110, the box is closed by shutting the lid 310 to keep out any light that may cure the light sensitive resin on the dental laminates 150.

As the dentist prepares the patient's teeth for the dental laminates 150, the dental laminates 150 are held in the box 300 and kept aside for the dentist until the dentist is ready to apply the dental laminates 150 to the patient's teeth. When the dentist is ready, the dentist opens the box 300 by opening the lid 310, easily detaches the dental laminates 150 from the attachment means 110 on the sheet 220, and places them on the patient's teeth. The sheet 220 can then be removed from the pad 210 and disposed of, thus exposing a new sheet 220 in the pad 210. The box 300 containing the pad 210 can then be stored or kept aside until the dentist is ready for placement of a new set of dental laminates 150 for a next patient. The base 200 and box 300 may be disposed of or autoclaved for re-use.

The box 300 may also be used be the dental laboratory for the initial placement of the dental laminates 150 to be brought to the dentist. The dentist may do the trial fitting taking the dental laminates 150 from the box 300 directly, and can put the dental laminates 150 back in the box 300 to be held securely until the dentist is ready for the final placement of the dental laminates 150.

The present invention provides several advantages that solves the problems with prior art methods. It provides the dentist with a place to hold the dental laminates securely so that the dental laminates do not move around, until the dentist is ready to place them onto a patient's teeth. This eliminates the possibility of a mix up of the laminates, and also prevents the possibility of a “missed” hand off from an assistant since the veneers are picked up directly by the dentist. The present invention assists in the trial fitting, holding and placement of the cement loaded veneers onto the teeth, and allows ample working time before the light sensitive resin hardens.

The present invention also provides for a box to hold the dental laminates that blocks out light that can cure the light sensitive resin placed on the dental laminates, before the dental laminates are placed on the patient's teeth. It also provides a convenient, cost-effective apparatus for holding dental laminates that is re-usable and efficient. The attachment means holds the dental laminates securely so they don't move around. The pad provides for multiple sheets that can each be used for holding the dental laminates. The apparatus is mobile and portable, and can be reusable or disposable.

The above description of the present invention is only the preferred embodiments of the invention. Various other combinations of holding the dental laminates are also possible. Any sort of container or housing may be used in lieu of the box 300 that provides for a similar function. Any type of attachment means may be used to hold the dental laminates securely to the sheet, and can be an adhesive or any type of non-slip material. The attachment means 110 can be of any shape, such as but not limited to circular or rectangular (such as the strips shown in the figures), and may be located anywhere on the sheet 100, may be of any size, and is preferably running along the center. Any sort of base 200 may be used that is either reusable or disposable, and can be autoclaved.

There are several other uses of the invention not limited by the preferred description and embodiment as described above. The invention may also have other uses in the medical or dental fields, and in other similar applications.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A kit for holding one or more dental laminates, the kit comprising:
a housing for blocking out light;
a holding means; and
attachment means for attaching one or more dental laminates to said holding means;
wherein said holding means is placed inside said housing.

2. The kit for holding one or more dental laminates according to claim 1, further comprising a base that attaches to said holding means, said base being placed inside said housing.

3. The kit for holding one or more dental laminates according to claim 1, wherein said holding means comprises a sheet.

4. The kit for holding one or more dental laminates according to claim 3, wherein said sheet is a resin sheet.

5. The kit for holding one or more dental laminates according to claim 1, wherein said holding means comprises a base.

6. The kit for holding one or more dental laminates according to claim 1, wherein said attachment means is an adhesive.

7. The kit for holding one or more dental laminates according to claim 6, wherein said adhesive is selected from the group consisting of cement, paste, glue, and epoxy resin.

8. The kit for holding one or more dental laminates according to claim 1, wherein said attachment means is a strip located at a mid-point of said holding means.

9. The kit for holding one or more dental laminates according to claim 8, wherein said strip is a double-sided adhesive strip.

10. The kit for holding one or more dental laminates according to claim 1, wherein said attachment means is a slip free material.

11. The kit for holding one or more dental laminates according to claim 1, wherein said holding means comprises a plurality of sheets forming a pad, each of said sheets having said attachment means and said sheets are attached to each other.

12. The kit for holding one or more dental laminates according to claim 11, further comprising a base attached to said pad, said base placed inside said housing.

13. The kit for holding one or more dental laminates according to claim 1, wherein said housing comprises an opaque box having a lid movable within an open and closed position.

14. The kit for holding one or more dental laminates according to claim 13, wherein said box is made of a material selected from the group consisting of wood, plastic, stainless steel and metal.

15. The kit for holding one or more dental laminates according to claim 1, wherein said one or more dental laminates have a light sensitive resin on a first side of said one or more dental laminates for bonding said one or more dental laminates to a patient's teeth.

16. An apparatus for holding one or more dental laminates, the apparatus comprising:
a sheet; and
an attachment means placed on said sheet for attaching one or more dental laminates to said sheet.

17. An apparatus for holding one or more dental laminates according to claim 16, further comprising a pad comprised of a plurality of sheets attached to each other, wherein said sheet is one of said plurality of sheets and each of said sheets has placed thereon said attachment means.

18. The apparatus for holding one or more dental laminates according to claim 17, further comprising a base attached to said pad.

19. The apparatus for holding one or more dental laminates according to claim 16, wherein said attachment means comprises an adhesive.

20. The apparatus for holding one or more dental laminates according to claim 19, wherein said adhesive is selected from the group consisting of cement, paste, glue, and epoxy resin.

21. The apparatus for holding one or more dental laminates according to claim 16, wherein said attachment means is a strip located at a mid-point of said sheets.

22. The apparatus for holding one or more dental laminates according to claim 21, wherein said strip is a double-sided adhesive strip.

23. The apparatus for holding one or more dental laminates according to claim 16, wherein said sheet is a resin sheet.

24. The apparatus for holding one or more dental laminates according to claim 17, further comprising a housing for holding said pad, said housing being opaque to block out light.

25. The apparatus for holding one or more dental laminates according to claim 24, wherein said housing comprises a box having a lid movable within an open and closed position.

26. The apparatus for holding one or more dental laminates according to claim 25, wherein said box is made of a material selected from the group consisting of wood, plastic, stainless steel and metal.

27. The apparatus for holding one or more dental laminates according to claim 16, wherein said one or more dental laminates have a light sensitive resin on a first side of said one or more dental laminates for bonding said one or more dental laminates to a patient's teeth.

28. An apparatus for holding one or more dental laminates, the apparatus comprising:
a base; and
an attachment means placed on said base for attaching one or more dental laminates to said base.

29. The apparatus for holding one or more dental laminates according to claim 28, wherein said attachment means comprises an adhesive.

30. The apparatus for holding one or more dental laminates according to claim 29, wherein said adhesive is selected from the group consisting of cement, paste, glue, and epoxy resin.

31. The apparatus for holding one or more dental laminates according to claim 28, wherein said attachment means is a strip located at a mid-point of said base.

32. The apparatus for holding one or more dental laminates according to claim 31, wherein said strip is a double-sided adhesive strip.

33. The apparatus for holding one or more dental laminates according to claim 28, further comprising a housing for holding said base, said housing being opaque to block out light.

34. The apparatus for holding one or more dental laminates according to claim 33, wherein said housing comprises a box having a lid movable within an open and closed position.

35. The apparatus for holding one or more dental laminates according to claim 34, wherein said box is made of a material selected from the group consisting of wood, plastic, stainless steel and metal.

36. A method of inserting one or more dental laminates onto a patient's teeth, said method comprising:
fitting one or more dental laminates onto a patient's teeth;
loading a light sensitive resin onto said one or more dental laminates; and
placing said one or more dental laminates onto a sheet having an attachment means for holding and securing said one or more dental laminates onto said sheet.

37. The method of inserting one or more dental laminates onto a patient's teeth of claim 36, said method further comprising:
removing said one or more dental laminates from said sheet for placement into a mouth of a patient.

38. The method of inserting one or more dental laminates onto a patient's teeth of claim 36, said method further comprising:
covering said one or more dental laminates to block out light.

39. The method of inserting one or more dental laminates onto a patient's teeth of claim 38, wherein said covering step comprises holding said one or more dental laminates on said sheet in an opaque box.

40. The method of inserting dental laminates onto a patient's teeth of claim 36, said method further comprising:
detaching said sheet from a pad comprising a plurality of sheets, thereby exposing a new sheet in said pad.

41. The method of inserting dental laminates onto a patient's teeth of claim 36, further comprising loading said light sensitive resin onto a first side of said one or more dental laminates, and placing a second side of said one or more dental laminates on said sheet.
